(19) United States
(12) Patent Application Publication
(10) Pub. No.: US 2026/0162429 A1
(43) Pub. Date: Jun. 11, 2026

(54) ZERO-SHOT VIDEO CHANGE DETECTION SYSTEMS AND METHODS

(71) Applicant: HITACHI, Ltd., Tokyo (JP)

(72) Inventors: Mahbubul ALAM, Fremont, CA (US); Maria Teresa GONZALEZ DIAZ, Morgan Hill, CA (US); Huimin ZHUGE, San Jose, CA (US); Ahmed FARAHAT, Santa Clara, CA (US); Song WANG, San Carlos, CA (US); Chetan GUPTA, Sunnyvale, CA (US)

(21) Appl. No.: 18/970,168

(22) Filed: Dec. 5, 2024

(51) Int. Cl. G06V 20/40; G06V 10/82

(52) U.S. Cl. CPC G06V 20/46; G06V 10/82

(57) ABSTRACT

Few-shot and zero-shot video change detection systems and methods for identifying changes in video images described herein involve a frame matching process that comprises identifying matching pairs of frames from a pair of input videos; a color translation process that comprises adjusting lighting condition between the matching pairs; an image alignment process that comprises adjusting misalignments between the matching frames; an object detection process that comprises utilizing a pre-trained deep learning object detection model to identify objects in both the matching frames; and an object comparison process that comprises finding non-overlapped objects between each pair of video frames to identify the changes in for industrial and other applications.

### BACKGROUND

### Field

The present disclosure is generally directed to video change detection, and more specifically, to systems and methods for few-shot and zero-shot video change detection for use in industrial and other applications.

### Related Art

Change detection between a pair of images or videos has many applications, including in industrial applications, such as in manufacturing, anomaly detection, warehouse maintenance, and safety. Change detection involves identifying the addition or removal of certain objects in a scene as well as subtle changes in the scene itself, while ignoring slight changes in the background.

Sophisticated deep learning-based techniques are utilized for identifying changes between a pair of images or videos. One major limitation of video change detection over image change detection is the lack of a large collection of public video change detection datasets. Unlike videos, collecting custom-labeled image change detection data is straightforward for training a substantially large deep neural network model such as Siamese networks, which take a pair of images as input and output the corresponding change areas in the image.

Such existing video change detection techniques oftentimes rely on pixel-based or feature-based change detection mechanisms, which are not well-suited for identifying changes between videos with varying backgrounds. Some existing deep learning-based video change detection algorithms utilize a fully Convolutional Siamese metric Network (CosimNet) to detect changes by directly comparing dissimilarities between a pair of features extracted from the videos. Additionally, deep learning-based change detection methods trained using specific datasets that are time-consuming, cumbersome, and expensive to acquire may fail to adapt to new locations and applications. Moreover, existing methods are often task-specific and, hence, difficult to generalize across different applications, thus limiting their usefulness.

Accordingly, it would be beneficial to have few-shot, ideally, a zero-shot video change detection systems and methods, especially for industrial applications where labeled data is scarce.

### SUMMARY

In some aspects of the disclosure, a zero-shot video change detection method for identifying changes in video images comprises: using a deep learning-based process to identify matching pairs of frames from a pair of input videos, wherein frames in the matching pairs of frames are considered a match if their similarity score exceeds a predefined threshold; using a color translation process to adjust lighting conditions between the matching pairs of frames; aligning the matching pairs of frames to correct disparities and to ensure that regions of interest between the matching pairs of frames overlap; in response to the matching pairs of frames being aligned, using a deep neural network model that has been trained to detect an object to detect an addition or a removal associated with an object of interest common to each frame in the matching pairs of frames; and detecting one or more changes between the matching pairs of frames by identifying one or more non-overlapped regions that include the object of interest.

In some aspects, the deep neural network model has been trained on a large dataset of generic labeled images.

In some aspects, the method further comprises applying an image augmentation technique to enhance robustness of the deep neural network model.

In some aspects, the image augmentation technique comprises at least one of a cropping operation, a rotating operation, a scaling operation, a brightness operation, a contrast operation, or an exposure operation.

In some aspects, the deep neural network model has been trained to classify an object associated with a unique object type.

In some aspects, aligning the matching pairs of frames comprises at least one of a scaling operation, a translation operation, or a rotation operation to adjust for a difference in alignment between the pair of input videos.

In some aspects, the deep learning-based process comprises using a similarity learning model that is configured to identify the matching pairs of frames based on feature similarity.

In some aspects, the similarity learning model is trained to maximize a matching accuracy between frames that have different backgrounds and different lighting conditions.

In some aspects, the similarity score is computed by using a cosine similarity metric.

In some aspects, the techniques described herein relate to a non-transitory computer-readable medium for storing instructions for executing a process, the instructions including: using a deep learning-based process to identify matching pairs of frames from a pair of input videos, wherein frames in the matching pairs of frames are considered a match if their similarity score exceeds a predefined threshold; using a color translation process to adjust lighting conditions between the matching pairs of frames; aligning the matching pairs of frames to correct disparities and to ensure that regions of interest between the matching pairs of frames overlap; in response to the matching pairs of frames being aligned, using a deep neural network model that has been trained to detect an object(s) of interest common to each frame in the matching pairs of frames; and detecting one or more changes between the matching pairs of frames by identifying one or more non-overlapped regions that include the object of interest.

In some aspects, the frames in the matching pairs of frames are considered a match if their similarity score exceeds a predefined threshold. A similarity score may be computed, for example, by using a cosine similarity metric. The deep learning-based process may comprise using a similarity learning model that is configured to identify the matching pairs of frames based on feature similarity. The similarity learning model may be trained to maximize a matching accuracy between frames that have different backgrounds and lighting conditions. The deep neural network model may have been trained on a large dataset of generic labeled images, and may have been trained to classify an object associated with a unique object type.

In some aspects, aligning may further comprise a scaling operation, a translation operation, or a rotation operation to adjust for a difference in alignment between the pair of input videos. In some aspects, an image augmentation technique may be applied to enhance robustness of the deep neural network model, and may comprise at least one of a cropping operation, a rotating operation, a scaling operation, a brightness operation, a contrast operation, or an exposure operation.

In some aspects, the techniques described herein relate to an apparatus, including: a processor, configured to: use a deep learning-based process to identify matching pairs of frames from a pair of input videos, wherein frames in the matching pairs of frames are considered a match if their similarity score exceeds a predefined threshold; use a color translation process to adjust lighting conditions between the matching pairs of frames; align the matching pairs of frames to correct disparities and to ensure that regions of interest between the matching pairs of frames overlap; in response to the matching pairs of frames being aligned, use a deep neural network model that has been trained to detect an object to detect an addition or a removal associated with an object of interest common to each frame in the matching pairs of frames; and detect one or more changes between the matching pairs of frames by identifying one or more non-overlapped regions that include the object of interest.

Aspects of the present disclosure can involve a system, which can involve means for performing steps comprising using a deep learning-based process to identify matching pairs of frames from a pair of input videos, wherein frames in the matching pairs of frames are considered a match if their similarity score exceeds a predefined threshold, and using a color translation process to adjust lighting conditions between the matching pairs of frames.

Aspects of the present disclosure can involve a system, which can involve means for performing steps comprising aligning the matching pairs of frames to correct disparities and to ensure that regions of interest between the matching pairs of frames overlap; means for performing steps comprising in response to the matching pairs of frames being aligned, means for performing steps comprising using a deep neural network model that has been trained to detect an object to detect an addition or a removal associated with an object of interest common to each frame in the matching pairs of frames; and means for performing steps comprising detecting one or more changes between the matching pairs of frames by identifying one or more non-overlapped regions that include the object of interest.

### BRIEF DESCRIPTION OF DRAWINGS

FIG. 1 is an overview of an exemplary zero-shot video change detection flow according to various embodiments of the present disclosure.

FIG. 2 depicts a frame matching process according to various embodiments of the present disclosure.

FIG. 3 illustrates a color translation process according to various embodiments of the present disclosure.

FIG. 4 illustrates an image alignment process according to various embodiments of the present disclosure.

FIG. 5 illustrates an image object detection process according to various embodiments of the present disclosure.

FIG. 6A and FIG. 6B illustrate an object comparison process according to various embodiments of the present disclosure.

FIG. 7 is a flowchart illustrating an exemplary zero-shot video change detection process for identifying changes in video images, in accordance with various embodiments of the present disclosure.

FIG. 8 illustrates an example computing environment according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Embodiments herein involve a zero-shot video change detection method that utilizes pre-trained deep learning models and image processing and computer vision techniques. An exemplary zero-shot video change detection process may involve steps comprising: i) identifying matching pairs of frames from a pair of input videos, ii) adjusting lighting conditions between the matching pairs, iii) correcting any misalignment between the matching frames, iv) utilizing an pre-trained deep learning object detection model to identify objects in both matching frames, and v) detecting changes in by identifying non-overlapped objects between each pair of video frames. Various embodiments herein are easily generalizable with minimal modifications to the above-mentioned steps.

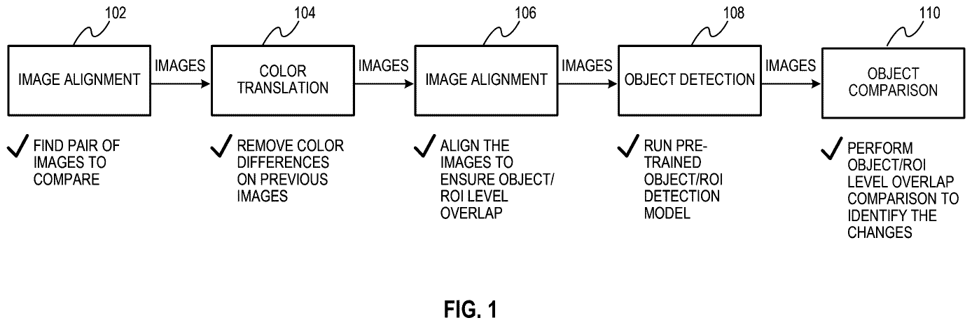

FIG. 1 is an overview of an exemplary zero-shot video change detection process according to various embodiments of the present disclosure. Process 100 for zero-shot video change detection may comprise a combination of image processing methods, traditional computer vision methods, and AI methods. As depicted, process 100 comprises a series of sub-processes, including frame matching process 102, color translation process 104, image alignment process 106, object detection process 108, and object comparison process 110.

In embodiments, frame matching process 102 comprises identifying matching pairs of frames from a pair of input videos; color translation process 104 comprises adjusting lighting condition between the matching pairs; image alignment process 106, comprises adjusting misalignments between the matching frames; object detection process 108 comprises utilizing a pre-trained deep learning object detection model to identify objects in both the matching frames; and object comparison process 108 comprises finding non-overlapped objects between each pair of video frames to identify the changes.

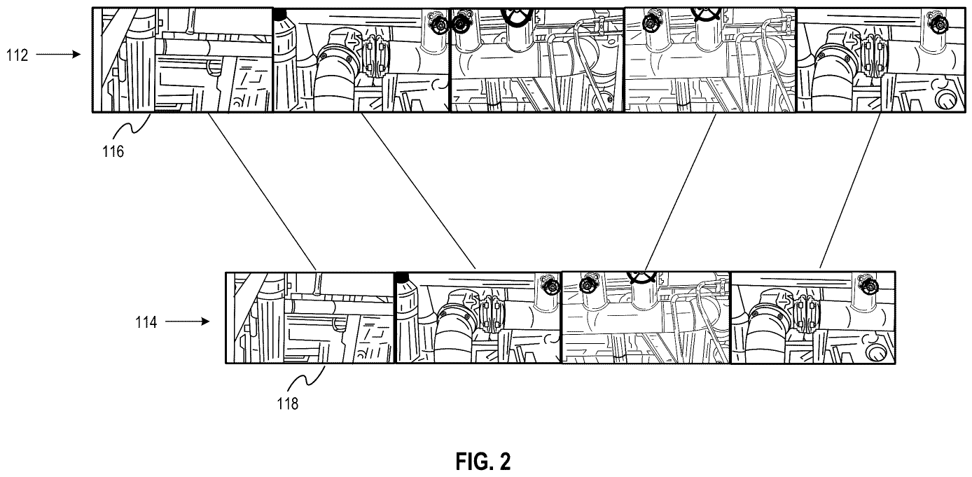

FIG. 2-6 illustrate the sub-processes in the zero-shot change detection process shown in FIG. 1. In embodiments, a zero-shot change detection process according to various embodiments of the present disclosure may be used, for example, to inspect rental cars for potential physical damage by observing images of cars taken immediately before they are rented out and immediately after their return. For simplicity, hereinafter, videos in a pair of videos are referred to as the before video and the after video, respectively.

FIG. 2 depicts a frame matching process according to various embodiments of the present disclosure. Depicted are the first few frames from before video 112 and the first few frames from after video 114. FIG. 2 also illustrates that the frames of the before video 112 and the after video 114 are initially misaligned. In embodiments, frame matching process 102 comprises identifying corresponding pairs of frames (e.g., 116 and 118) from the after 114 video by comparing them with frames from the before 112 video. A frame matching process may be performed, for example, by using a modified version of an existing video similarity learning process. In such settings, two frames (e.g., 116 and 118) are considered a match if a similarity score exceeds a certain threshold.

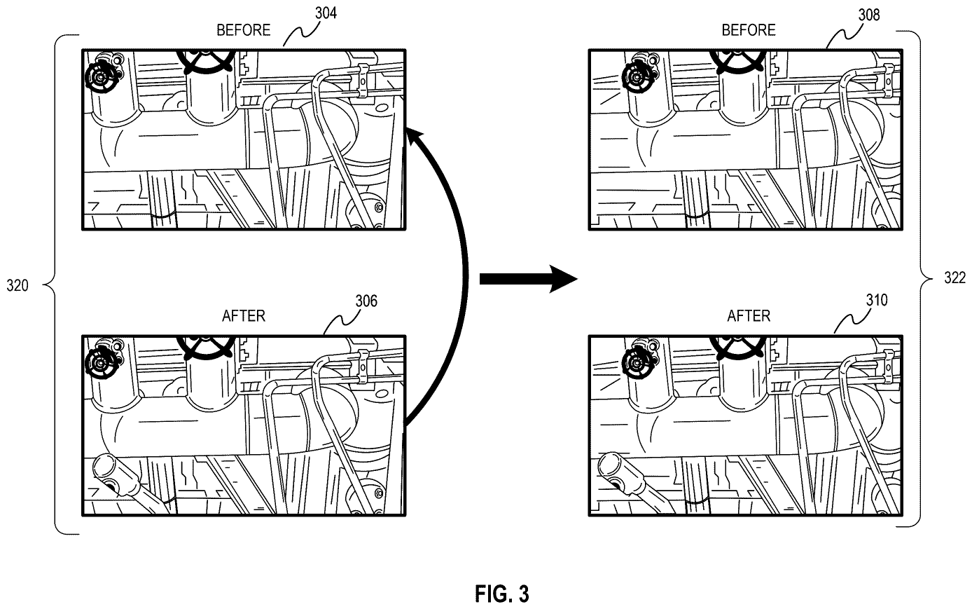

FIG. 3 illustrates a color translation process 104 according to various embodiments of the present disclosure. Since two videos may have been captured at different times of the day, in embodiments, color translation process 104 may be used to adjust the lighting conditions between each before and after pair (e.g., 320) of matched frames 304 & 306 and 308 & 310. It is understood that to perform the lighting condition adjustments on a before and after frame pair 320, 322 to reduce or eliminate color differences, a suitable color transfer image processing method may be utilized.

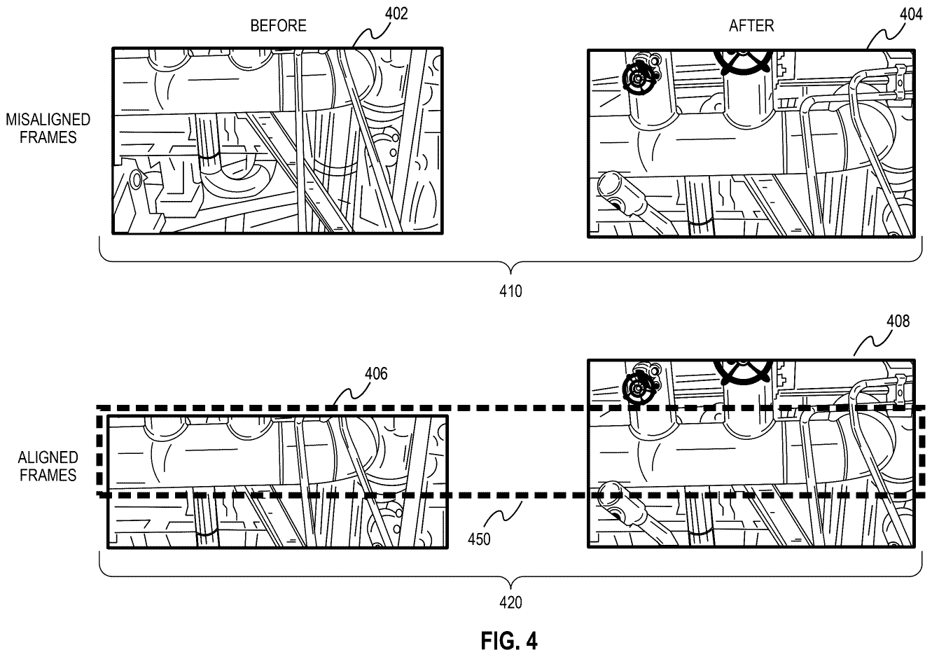

FIG. 4 illustrates an image alignment process 106 according to various embodiments of the present disclosure. Depicted are before and after frame pairs 410, 420 that each comprise respective before and after frames 402 & 404 and 406 & 408. Each frame may comprise a region of interest (ROI) 450, e.g., a part of interest. In embodiments, before and after frames 402, 404 may be aligned such as to ensure that existing ROIs 450 in before and after frames pair 420 overlaps.

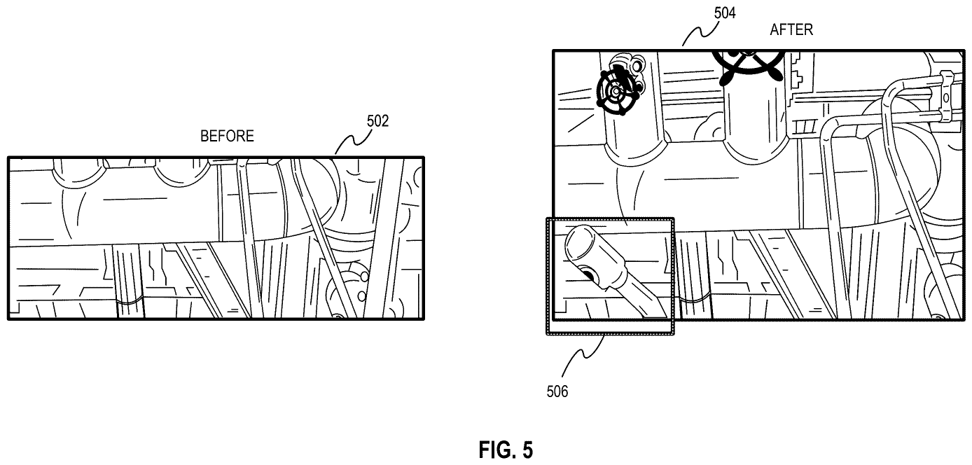

FIG. 5 illustrates an image object detection process 108 according to various embodiments of the present disclosure. In embodiments, a pre-trained change detection model, e.g., a you-only-look-once (YOLO) detection model may be used to obtain, within a ROI, a bounding box 506 in any before frame 502 and after frame 504, each ROI comprising an object of interest. Suitable objects of interest may be, for example, indicia of physical damage. However, this is not intended as a limitation on the scope of the present disclosure as any other objects of interest may be desirable depending on a particular application.

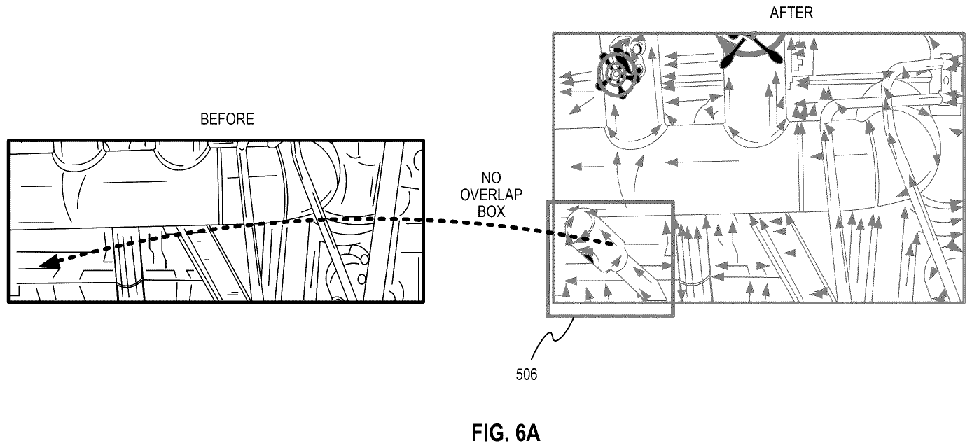

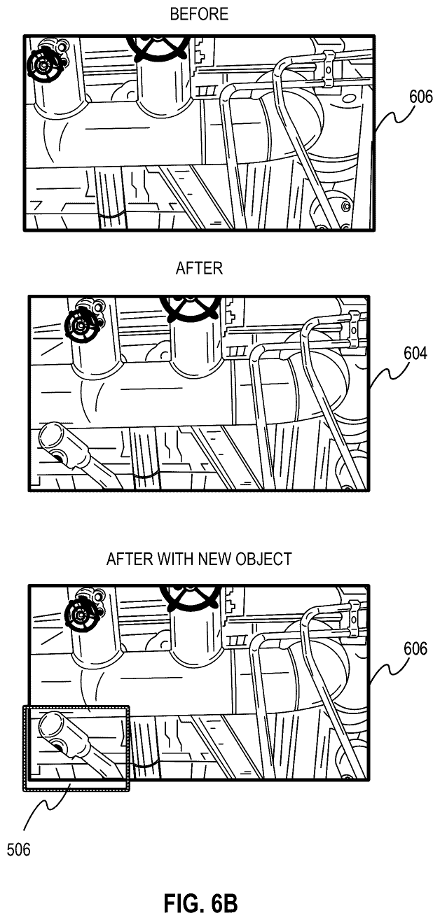

FIG. 6A and FIG. 6B illustrate an object comparison process according to various embodiments of the present disclosure. In embodiments, overlaps between bounding boxes comprising objects of interest in the before frame 602 and after frame 604 may be identified. As depicted in FIG. 6B, the detected changes may be visualized on a user-friendly interface, providing detailed insights into the type and extent of changes observed.

It is understood that, in various industrial applications, the detected changes may be logged and analyzed for further inspection or maintenance planning operations. It is further understood that, although the invention is generally described in the context of defect detection, this is not intended to limit the scope of the present disclosure to such embodiments as the teachings of the present discourse may be adapted to apply in various other applications such as in warehouse maintenance, for insurance claim processing, in manufacturing, and safety-related applications.

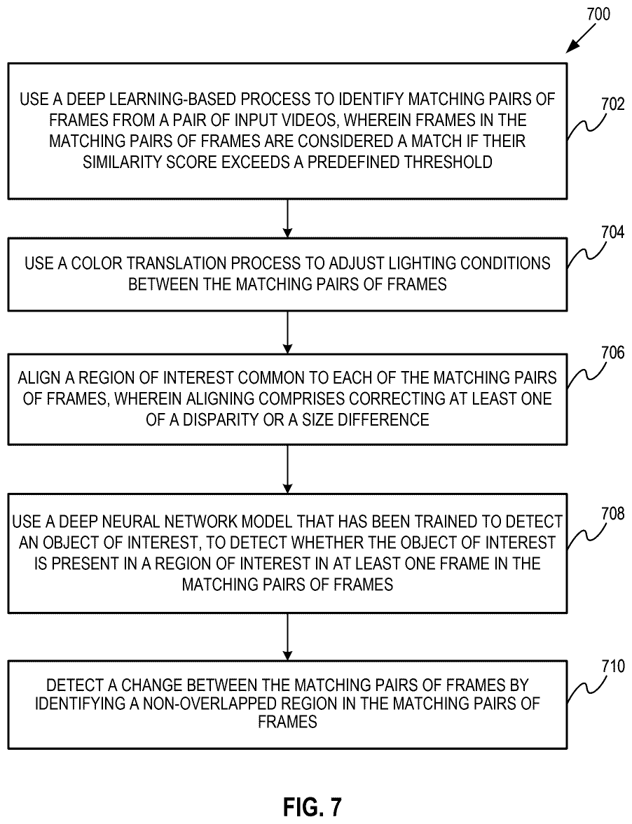

FIG. 7 is a flowchart illustrating an exemplary zero-shot video change detection process for identifying changes in video images, in accordance with various embodiments of the present disclosure. In embodiments, process 700 may start at step 702 when a deep learning-based process is used to identify matching pairs of frames from a pair of input videos. The frames in the matching pairs of frames are considered a match if their similarity score exceeds a predefined threshold. A similarity score may be computed, for example, by using a cosine similarity metric. The deep learning-based process may comprise using a similarity learning model that is configured to identify the matching pairs of frames based on feature similarity. In embodiments, the similarity learning model may be trained to maximize a matching accuracy between frames that have different backgrounds and lighting conditions.

At step 704, a color translation process may be used to adjust lighting conditions between the matching pairs of frames.

At step 706, a region of interest common to each of the matching pairs of frames may be aligned. In embodiments, aligning may comprise correcting at least one of a disparity or a size difference. Aligning may further comprise a scaling operation, a translation operation, or a rotation operation to adjust for a difference in alignment between the pair of input videos.

At step 708, a deep neural network model, which has been trained to detect an object of interest, may be used to detect whether the object of interest is present in a region of interest in at least one frame in the matching pairs of frames. The deep neural network model may have been trained on a large dataset of generic labeled images. In embodiments, an image augmentation technique may be applied to enhance robustness of the deep neural network model.

Finally, at step 710, a change between the matching pairs of frames may be detected by identifying a non-overlapped region in the matching pairs of frames.

One skilled in the art shall recognize that: (1) certain steps may optionally be performed; (2) steps may not be limited to the specific order set forth herein; (3) certain steps may be performed in different orders; and (4) certain steps may be done concurrently.

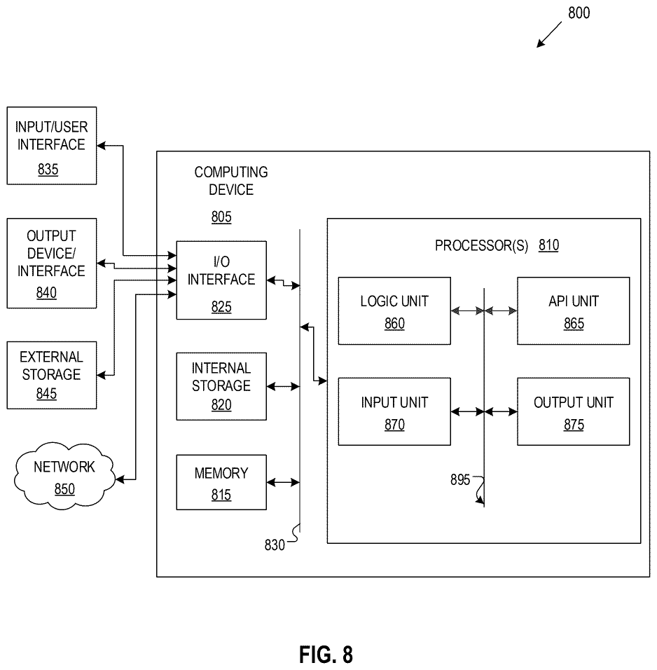

FIG. 8 illustrates an example computing environment with an example computer device suitable for use in some example implementations according to various embodiments of the present disclosure. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configurations. Computer device 805 or any connected computer device can be functioning as, providing services of, or referred to as a server, client, thin server, general machine, special-purpose machine, or another label.

I/O interface 825 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, a satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, and output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in example implementations.

Processor(s) 810 can be configured to execute a method or computer instructions which can involve using a deep learning-based process to identify matching pairs of frames from a pair of input videos, wherein frames in the matching pairs of frames are considered a match if their similarity score exceeds a predefined threshold, as described, for example, with respect to FIG. 2.

Processor(s) 810 can be configured to execute a method or computer instructions which can involve using a color translation process to adjust lighting conditions between the matching pairs of frames, as described, for example, with respect to FIG. 3.

Processor(s) 810 can be further configured to execute a method or computer instructions which can involve aligning the matching pairs of frames to correct disparities and to ensure that regions of interest between the matching pairs of frames overlap, as described, for example, with respect to FIG. 4.

Processor(s) 810 can also be configured to execute a method or computer instructions which can involve, in response to the matching pairs of frames being aligned, using a deep neural network model that has been trained to detect an object to detect an addition or a removal associated with an object of interest common to each frame in the matching pairs of frames, as described, for example, with respect to FIG. 5.

Finally, processor(s) 810 can be configured to execute a method or computer instructions which can involve detecting one or more changes between the matching pairs of frames by identifying one or more non-overlapped regions that include the object of interest, as described, for example, with respect to FIG. 6A and FIG. 6B.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A zero-shot video change detection method for identifying changes in video images, the method comprising:
using a deep learning-based process to identify matching pairs of frames from a pair of input videos, wherein frames in the matching pairs of frames are considered a match if their similarity score exceeds a predefined threshold;
using a color translation process to adjust lighting conditions between the matching pairs of frames;
aligning the matching pairs of frames to correct disparities and to ensure that regions of interest between the matching pairs of frames overlap;
in response to the matching pairs of frames being aligned, using a deep neural network model that has been trained to detect an object to detect an addition or a removal associated with an object of interest common to each frame in the matching pairs of frames; and
detecting one or more changes between the matching pairs of frames by identifying one or more non-overlapped regions that comprise the object of interest.

2. The method of claim 1, wherein the deep neural network model has been trained on a large dataset of generic labeled images.

3. The method of claim 2, further comprising applying an image augmentation technique to enhance robustness of the deep neural network model.

4. The method of claim 3, wherein the image augmentation technique comprises at least one of a cropping operation, a rotating operation, a scaling operation, a brightness operation, a contrast operation, or an exposure operation.

5. The method of claim 1, wherein the deep neural network model has been trained to classify an object associated with a unique object type.

6. The method of claim 1, wherein aligning the matching pairs of frames comprises at least one of a scaling operation, a translation operation, or a rotation operation to adjust for a difference in alignment between the pair of input videos.

7. The method of claim 1, wherein the deep learning-based process comprises using a similarity learning model that is configured to identify the matching pairs of frames based on feature similarity.

8. The method of claim 7, wherein the similarity learning model is trained to maximize a matching accuracy between frames that have different backgrounds and different lighting conditions.

9. The method of claim 1, wherein the similarity score is computed by using a cosine similarity metric.

10. A non-transitory computer-readable medium for storing instructions for executing a process, the instructions comprising:
using a deep learning-based process to identify matching pairs of frames from a pair of input videos, wherein frames in the matching pairs of frames are considered a match if their similarity score exceeds a predefined threshold;
using a color translation process to adjust lighting conditions between the matching pairs of frames;
aligning the matching pairs of frames to correct disparities and to ensure that regions of interest between the matching pairs of frames overlap;
in response to the matching pairs of frames being aligned, using a deep neural network model that has been trained to detect an object to detect an addition or a removal associated with an object of interest common to each frame in the matching pairs of frames; and
detecting one or more changes between the matching pairs of frames by identifying one or more non-overlapped regions that comprise the object of interest.

11. The non-transitory computer-readable medium of claim 10, wherein the deep neural network model has been trained on a large dataset of generic labeled images.

12. The non-transitory computer-readable medium of claim 11, further comprising applying an image augmentation technique to enhance robustness of the deep neural network model.

13. The non-transitory computer-readable medium of claim 12, wherein the image augmentation technique comprises at least one of a cropping operation, a rotating operation, a scaling operation, a brightness operation, a contrast operation, or an exposure operation.

14. The non-transitory computer-readable medium of claim 10, wherein the deep neural network model has been trained to classify an object associated with a unique object type.

15. The non-transitory computer-readable medium of claim 10, wherein aligning the matching pairs of frames comprises at least one of a scaling operation, a translation operation, or a rotation operation to adjust for a difference in alignment between the pair of input videos.

16. The non-transitory computer-readable medium of claim 10, wherein the deep learning-based process comprises using a similarity learning model that is configured to identify the matching pairs of frames based on feature similarity.

17. The non-transitory computer-readable medium of claim 16, wherein the similarity learning model is trained to maximize a matching accuracy between frames that have different backgrounds and different lighting conditions.

18. The non-transitory computer-readable medium of claim 10, wherein the similarity score is computed by using a cosine similarity metric.

19. An apparatus, comprising:
a processor, configured to:
use a deep learning-based process to identify matching pairs of frames from a pair of input videos, wherein frames in the matching pairs of frames are considered a match if their similarity score exceeds a predefined threshold;
use a color translation process to adjust lighting conditions between the matching pairs of frames;
align the matching pairs of frames to correct disparities and to ensure that regions of interest between the matching pairs of frames overlap;
in response to the matching pairs of frames being aligned, use a deep neural network
model that has been trained to detect an object to detect an addition or a removal associated with an object of interest common to each frame in the matching pairs of frames; and
detect one or more changes between the matching pairs of frames by identifying one or more non-overlapped regions that comprise the object of interest.

20. The apparatus of claim 19, wherein the deep learning-based process comprises using a similarity learning model that is configured to identify the matching pairs of frames based on feature similarity, the similarity learning model having been trained to maximize a matching accuracy between frames that have different backgrounds and different lighting conditions.
